(19) United States
(12) Patent Application Publication
(10) Pub. No.: US 2026/0277911 A1
(43) Pub. Date: Sep. 17, 2026

(54) MACHINE LEARNING (ML) PROMPT MANAGEMENT

(71) Applicant: INTERNATIONAL BUSINESS MACHINES CORPORATION, ARMONK, NY (US)

(72) Inventors: Peng Hui Jiang, Beijing (CN); Jun Su, Beijing (CN); Yin Xia, Beijing (CN); Jia Yu, Beijing (CN)

(21) Appl. No.: 19/081,284

(22) Filed: Mar. 17, 2025

(51) Int. Cl. G06F 16/2457; G06F 40/40

(52) U.S. Cl. CPC G06F 16/24575; G06F 40/40

(57) ABSTRACT

Aspects of the present disclosure relate to machine learning (ML) prompt management. A first prompt can be embedded to generate a first prompt vector. A similarity search can be performed using the first prompt vector to select a matching prompt vector, the matching prompt vector corresponding to a second prompt. The first prompt can be updated using the second prompt. The updated first prompt can be provided to a machine learning (ML) model, where the ML model generates an output based on the updated first prompt.

### BACKGROUND

The present disclosure relates generally to the field of computing, and in particular, to machine learning (ML) prompt management.

Artificial Intelligence (AI) is a broad field of computer science aimed at creating machines that match or exceed human intelligence, including perceiving, synthesizing, and inferring information. AI technology is used within many applications, including web search engines, recommendation systems, speech devices, autonomous vehicles, creative tools, and strategy games.

Machine learning (ML) is a branch of AI that relates to constructing mathematical models that automatically learn and improve from experience without being explicitly programmed. That is, ML refers to techniques for training machines to perform specific AI tasks. ML training involves providing an ML algorithm with training data to learn from. Training can refer to the overall process of developing an ML model, or the specific portion of the development process where parameters of the ML model are updated. Training typically aims at finding a set of values of model parameters (e.g., weights) that best describe training data.

Generative machine learning (ML) models are ML models that create new data (e.g., ML outputs) based on patterns learned from existing data. Large language models (LLMs) are an example generative ML model that can be configured to generate text, images, audio, and/or video data in response to a request. Generative ML model outputs can be guided based on input prompts. Prompts are queries (e.g., provided by a human in natural language) that are input into a generative ML model to produce an ML output. Prompt engineering is a process for creating and refining prompts to obtain desired ML outputs.

### SUMMARY

Aspects of the present disclosure relate to computer program products, systems, and methods for machine learning (ML) model prompt management. A first prompt can be embedded to generate a first prompt vector. A similarity search can be performed using the first prompt vector to select a matching prompt vector, the matching prompt vector corresponding to a second prompt. The first prompt can be updated using the second prompt. The updated first prompt can be provided to a machine learning (ML) model, where the ML model generates an output based on the updated first prompt.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example network environment including a machine learning (ML) prompt management system, in accordance with embodiments of the present disclosure.

FIG. 3 is a flowchart illustrating an example method for ML model prompt management, in accordance with embodiments of the present disclosure.

FIG. 4 is a flowchart illustrating another example method for ML model prompt management, in accordance with embodiments of the present disclosure.

FIG. 5 is a flowchart illustrating another example method for ML model prompt management, in accordance with embodiments of the present disclosure.

FIG. 6 is a diagram illustrating example prompt vectors and queries used for ML model prompt management, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and more particularly, to machine learning (ML) prompt management. While the present disclosure is not necessarily limited to such applications, various aspects of the disclosure may be appreciated through a discussion of various examples using this context.

As discussed above, Artificial Intelligence (AI) is a broad field of computer science aimed at creating machines that match or exceed human intelligence, including perceiving, synthesizing, and inferring information. AI technology is used within many applications, including web search engines, recommendation systems, speech devices, autonomous vehicles, creative tools, and strategy games.

Machine learning (ML) is a branch of AI that relates to constructing mathematical models that automatically learn and improve from experience without being explicitly programmed. That is, ML refers to techniques for training machines to perform specific AI tasks. ML training involves providing an ML algorithm with training data to learn from. Training can refer to the overall process of developing an ML model, or the specific portion of the development process where parameters of the ML model are updated. Training typically aims at finding a set of values of model parameters (e.g., weights) that best describe training data.

Training can occur in a supervised manner, where the ML model learns based on labeled training data. In supervised machine learning, a training dataset typically has labels for both inputs and corresponding output values. This enables the ML model to learn functions that map inputs to outputs, thereby enabling the ML model to make predictions on unseen data.

Training can also occur in a semi-supervised or unsupervised manner, where little to no labels are associated with training data the ML algorithm learns from. Unsupervised learning enables models to discover underlying patterns or structures (e.g., features used for predictions), such as clustering. In semi-supervised learning, a small amount of labeled data in combination with a large amount of unlabeled data can be injected during training, realizing the benefits of both supervised and unsupervised machine learning training methods.

Other manners for training ML models exist, such as reinforcement learning. Within reinforcement learning frameworks, ML algorithms learn by taking actions within an environment to maximize reward. This learning typically involves trial and error, where ML agents improve their policy over time based on feedback (e.g., reward and punishment) they receive after each action.

Large language models (LLMs) are a type of machine learning model designed for natural language tasks based on user input. User input used to guide LLM outputs can be referred to as “prompts.” Prompt engineering is a process that modifies user input provided to LLMs or other natural language-based models to produce improved ML outputs. However, traditional prompt engineering methodologies lack adaptability and contextuality, leading to suboptimal ML outputs. For example, current prompt engineering methods fail to account for the dynamic nature of user input and evolving language patterns. Further, current methods for prompt generation often struggle to maintain contextuality and relevancy, especially in complex and varied domains across different computing platforms. Aspects of the present disclosure address the above-mentioned complications, as will be further discussed herein.

The following description provides examples of embodiments of the present disclosure, and variations and substitutions may be made in other embodiments. Several examples will now be provided to further clarify various aspects of the present disclosure.

Example 1: A computer-implemented method that comprises embedding a first prompt to generate a first prompt vector. The method further comprises performing a similarity search using the first prompt vector to select a matching prompt vector, the matching prompt vector corresponding to a second prompt. The method further comprises updating the first prompt using the second prompt. The method further comprises providing the updated first prompt to a machine learning (ML) model, where the ML model generates an output based on the updated first prompt.

The above limitations advantageously enable updating accessed input prompts (e.g., during runtime, prior to runtime, or after runtime) based on similarity search results. The input prompt can be updated based on various features (e.g., performance metrics, query statements, data location recitations, user preferences, etc.) associated with a second prompt selected based on the similarity search. Such updates can improve ML execution of prompts (e.g., improve ML model performance, such as execution time), improve obtained ML outputs (e.g., improve ML model success rate), and improve input prompts by better matching user intent and/or user preferences. The above limitations further enable prompt searching functionalities via prompt embedding, For example, matching prompt vectors corresponding to the input prompt vector and identified via a similarity search can be obtained and used to modify the input prompt.

Example 2: The limitations of Example 1, where the similarity search returns a plurality of matching prompt vectors, wherein the selected matching prompt vector is selected from the plurality of matching prompt vectors.

The above limitations advantageously enable multiple prompt vectors (e.g., corresponding to respective prompts) to be identified via similarity searching. The selected matching prompt vector can be selected based on a ranking of one or more criteria associated with the plurality of matching prompt vectors. By selecting the matching prompt vector from the plurality of prompt vectors, advantageous features of the prompt corresponding to the matching prompt vector can be used to modify the input prompt such that the input prompt realizes advantages of features integrated into the input prompt. The modification of the input prompt can improve ML execution of prompts (e.g., improve ML model performance, such as execution time), improve obtained ML outputs (e.g., improve ML model success rate), and improve input prompts by better matching user intent and/or user preferences.

Example 3: The limitations of Example 2, where the selected matching prompt vector is selected from the plurality of matching prompt vectors based on a performance metric.

The above limitations advantageously enable the input prompt to be modified based on the second prompt which has improved performance metrics (e.g., improved execution time, reduced I/O count, improved resource utilization, etc.) as compared to other prompts corresponding to the plurality of matching prompt vectors that were not selected. For example, features of the second prompt (e.g., alphanumeric characters, query statements, syntactical structure, etc.) can be used to update the first prompt such that the first prompt realizes the improved performance metrics during ML model execution. This can improve ML model execution of the updated input prompt and/or provide improved ML model outputs when executing the updated first prompt.

Example 4: The limitations of any of Examples 2-3, where the selected matching prompt vector is selected from the plurality of matching prompt vectors based on a success rate.

The above limitations advantageously enable the input prompt to be modified based on the second prompt which has improved success rate (e.g., an improved proportion of satisfactory ML outputs versus unsatisfactory ML outputs based on ML model execution of the input prompt) as compared to other prompts corresponding to the plurality of matching prompt vectors that were not selected. For example, features of the second prompt (e.g., alphanumeric characters, query statements, syntactical structure, etc.) can be used to update the first prompt such that the first prompt realizes the improved success rate during ML model execution. This can improve ML model execution of the updated input prompt and/or provide improved ML model outputs when executing the updated first prompt.

Example 5: The limitations of any of Examples 1-4, where the first prompt vector captures metadata of the first prompt, wherein the metadata is used within the similarity search to select the matching prompt vector. The above limitations advantageously enable identification of prompts that are relevant to the first prompt based on similarity of metadata features. As such, only relevant prompts (e.g., as determined using the similarity search results based on the metadata captured within the first prompt vector) may be returned for the purpose of determining which prompts are used to update the input prompt. This may improve the selection process of matching prompts by ensuring unrelated prompts are not returned and used to update the input prompt. Improving the prompt selection process for prompts used to modify the input prompt can improve ML execution of prompts (e.g., improve ML model performance, such as execution time), improve obtained ML outputs (e.g., improve ML model success rate), and improve input prompts by better matching user intent and/or user preferences.

Example 6: The limitations of any of Examples 1-5, where prior to embedding the first prompt, the first prompt is formatted into a query language, wherein the formatted first prompt is embedded to generate the first prompt vector.

The above limitations advantageously improve prompt embedding and/or prompt vector similarity searching. For example, by formatting a natural language query corresponding to the first prompt into a query language (SQL), embedding performance may be enhanced due to the embedding model being able to better handle the query language format. Further, similarity searching results may be improved as a result of the prompt formatted into the query language format (e.g., based on the improved embedding of the first prompt). This can enable more accurate identification of matching prompts, which can improve ML execution of prompts (e.g., improve ML model performance, such as execution time), improve obtained ML outputs (e.g., improve ML model success rate), and improve input prompts by better matching user intent and/or user preferences.

Example 7: The limitations of any of Examples 1-6, where updating the first prompt using the second prompt includes generating a plurality of prompt candidates, wherein the updated first prompt is a finalized prompt selected from the plurality of prompt candidates based on a desired goal.

The above limitations advantageously enable the selection of a finalized prompt based on one or more desired goals. As such, the updated prompt may have improved structure and/or phrasing as compared to other candidate prompts. Further, the updated prompt may have improved performance metrics and/or data distribution statistics as compared to other potential candidate prompts. This can improve modification of the input prompt, which can improve ML execution of prompts (e.g., improve ML model performance, such as execution time), improve obtained ML outputs (e.g., improve ML model success rate), and improve input prompts by better matching user intent and/or user preferences.

Example 8: The limitations of Example 7, where the desired goal is based on a performance metric of the finalized prompt as compared to performance metrics of other prompts within the plurality of prompt candidates.

The above limitations advantageously enable the selection of a finalized prompt based on a performance metric goal. As such, the updated prompt may have improved structure and/or phrasing as compared to other candidate prompts. Further, the updated prompt may have improved performance metrics as compared to other potential candidate prompts. This can improve modification of the input prompt, which can improve ML execution of prompts (e.g., improve ML model performance, such as execution time), improve obtained ML outputs (e.g., improve ML model success rate), and improve input prompts by better matching user intent and/or user preferences.

Example 9: The limitations of any of Examples 1-8, where the similarity search is performed against a prompt vector database to return a plurality of matching prompt vectors based on cosine similarity.

The above limitations advantageously enable the identification of a plurality of matching prompt vectors similar to the input prompt vector based on cosine similarity. This can enable the identification of matching prompts that are relevant to the input prompt based on one or more criterion used to execute the similarity search. This can enable improved prompt modification, thereby improving ML execution of prompts (e.g., improve ML model performance, such as execution time), improving obtained ML outputs (e.g., improve ML model success rate), and improving input prompts by better matching user intent and/or user preferences.

Example 10: A system comprising a processor set, one or more computer-readable storage media, and program instructions stored on the one or more computer-readable storage media to cause the processor set to perform the method according to any of Examples 1-9. The system of Example 10 realizes the benefits described with respect to Examples 1-9. The system of Example 10 can advantageously be implemented into a variety of computing devices.

Example 11: The limitations of Example 10, where the similarity search returns a plurality of matching prompt vectors, wherein the selected matching prompt vector is selected from the plurality of matching prompt vectors based on a performance metric.

The above limitations realize the technical benefits discussed with respect to Examples 2-3.

Example 12: The limitations of Example 11, where the performance metric used to select the matching prompt vector from the plurality of matching prompt vectors is an execution time, wherein the selected matching prompt vector has a top-ranked execution time.

The above limitations realize the technical benefits described with respect to Examples 2-3. Further, the above limitations improve modification of the input prompt. For example, the improved modification of the input prompt can result in improved ML model execution time.

Example 13: The limitations of Example 11, where the performance metric used to select the matching prompt vector from the plurality of matching prompt vectors is a resource utilization, wherein the selected matching prompt vector has a top-ranked resource utilization.

The above limitations realize the technical benefits described with respect to Examples 2-3. Further, the above limitations improve modification of the input prompt. For example, the improved modification of the input prompt can result in improved ML model execution via a reduction in resource utilization. This can improve performance of the system due to reduced resource utilization during ML model execution.

Example 14: The limitations of Example 11, where the selected matching prompt vector is selected from the plurality of matching prompt vectors based on the performance metric and a success rate.

The above limitations realize the technical benefits described with respect to Examples 2-3. Further, the above limitations improve modification of the input prompt. For example, the improved modification of the input prompt can result in improved ML model execution time and improved ML model output success rate.

Example 15: The limitations of any of Examples 10-14, where the similarity search returns a plurality of matching prompt vectors, where the selected matching prompt vector is selected from the plurality of matching prompt vectors based on data distribution statistics of the selected matching prompt vector as compared to the other matching prompt vectors.

The above limitations realize the technical benefits described with respect to Example 2. Further, the above limitations improve selection of the matching prompt vector. For example, the matching prompt vector may have improved data distribution statistics (e.g., fewer referenced/searched data locations, smaller referenced/searched data locations, etc.). This can improve ML model execution performance and ML model output results.

Example 16: A computer program product comprising one or more computer readable-storage media and program instructions collectively stored on the one or more computer readable storage media to perform the method according to any of Examples 1-15. The computer program product of Example 16 realizes the benefits described with respect to Examples 1-16. The computer program product of Example 16 can advantageously be implemented into a variety of computer program products.

Example 17: The limitations of Example 16, where updating the first prompt using the second prompt includes generating a plurality of prompt candidates.

The above limitations advantageously realize the technical benefits described with respect to Example 7.

Example 18: The limitations of Example 16, where the plurality of prompt candidates are executed on by the ML model to produce respective ML outputs.

The above limitations advantageously enable the ML model to execute on the plurality of prompt candidates to produce respective ML outputs. This can enable selection of a prompt candidate from the plurality of prompt candidates based on one or more criterion.

Example 19: The limitations of Example 18, wherein the updated first prompt is a finalized prompt selected from the plurality of prompt candidates based on a top-ranked performance metric with respect to the ML model execution.

The above limitations advantageously realize the technical benefits described with respect to Examples 7-8.

Example 20: The limitations of any of Examples 16-19, where similarity search is performed against a prompt vector database to return a plurality of matching prompt vectors based on a distance metric, wherein the selected matching prompt vector has a closest distance metric.

The above limitations advantageously realize the technical benefits described with respect to Example 9.

Example 21: A computer-implemented method that comprises embedding a first prompt to generate a first prompt vector. The method further comprises performing a similarity search using the first prompt vector to select a matching prompt vector, the matching prompt vector corresponding to a second prompt, where the similarity search is performed against a prompt vector database to return a plurality of matching prompt vectors based on a distance metric, wherein the selected matching prompt vector has a closest distance metric to the first prompt vector. The method further comprises updating the first prompt using the second prompt, wherein updating the first prompt using the second prompt includes generating a plurality of prompt candidates and selecting a finalized prompt from the plurality of prompt candidates based on the finalized prompt having a top-ranked performance metric as compared to other prompt candidates within the plurality of prompt candidates. The method further comprises providing the updated first prompt to a machine learning (ML) model, where the ML model generates an output based on the updated first prompt.

The above limitations advantageously realize the technical benefits described with respect to Examples 2-3, 7-8, and 17-20.

Aspects of the present disclosure can be implemented in a variety of technical use cases. For example, aspects of the present disclosure can be implemented within generative machine learning systems, such as large language models (LLMs). This can enable real-time updating of prompts provided by users to improve ML model performance, ML model outputs, and/or input prompt generation (e.g., improved prompt intent and/or prompts that better match user preferences). As such, upon accessing a prompt input to an LLM during run-time, aspects of the present disclosure can update the prompt prior to, or after, the LLM executing on the prompt and returning ML outputs. Aspects of the present disclosure can be implemented in any machine learning use case in which user input in the form of natural language and/or query statements is used to guide ML outputs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

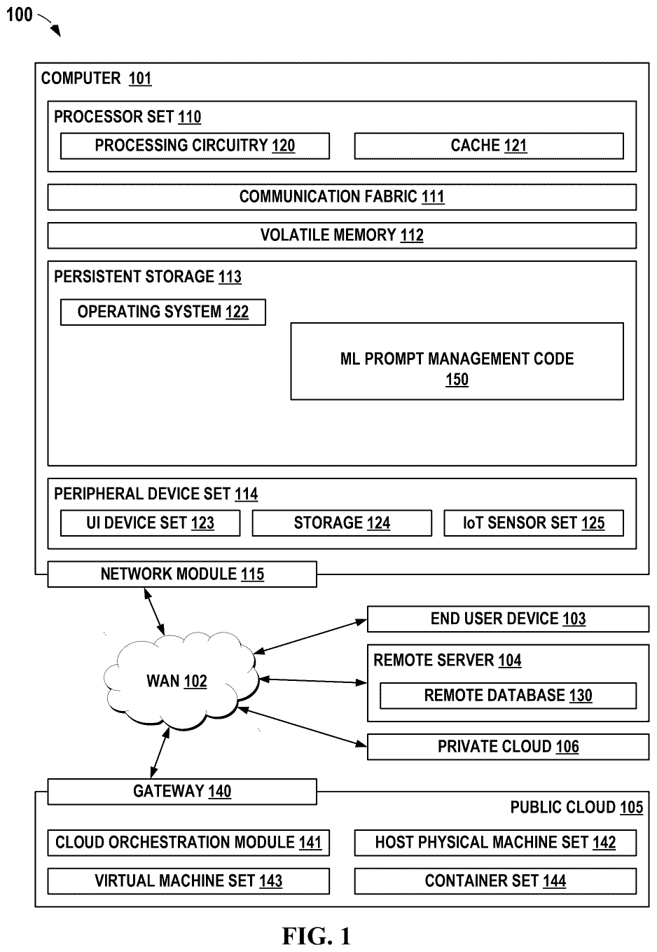

FIG. 1 is a high-level block diagram illustrating an example computing environment 100 that can be used in implementing one or more of the methods, tools, modules, and any related functions described herein, in accordance with embodiments of the present disclosure.

Computing environment 100 contains an example of an environment for the execution of at least some of the computer code involved in performing the inventive methods, such as ML prompt management code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ML prompt management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in ML prompt management code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in ML prompt management code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

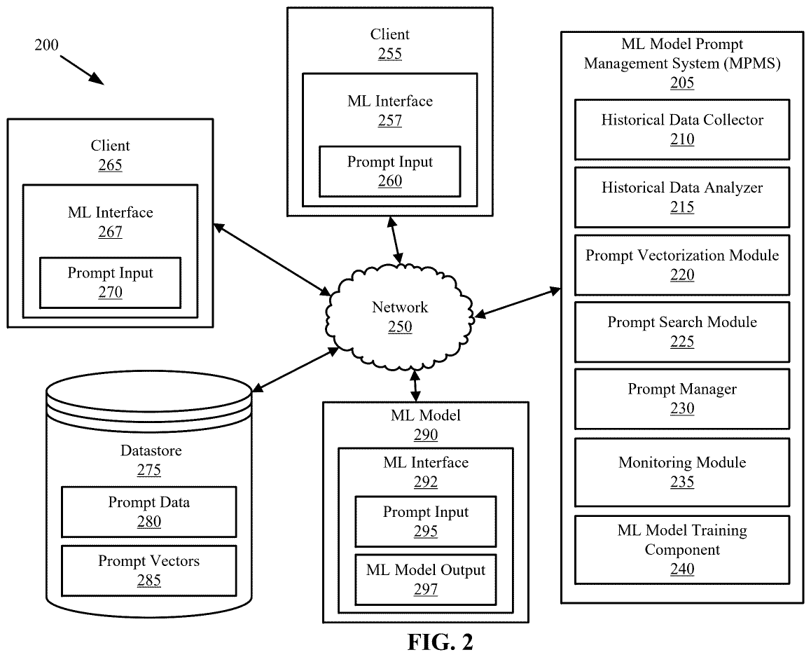

Referring now to FIG. 2, shown is a block diagram illustrating an example network environment 200 in which illustrative embodiments of the present disclosure can be implemented. The network environment 200 includes a machine learning (ML) model prompt management system (MPMS) 205, clients 255 and 265, and a datastore 275, each of which can be communicatively coupled for intercomponent interaction via a network 250. In embodiments, the network 250 can be the same as, or substantially similar to, WAN 102 of FIG. 1. In embodiments, the clients 255/265 and MPMS 205 can be the same as, or substantially similar to, computer 101, remote server 104, peripheral device set 114, and/or EUD 103 of FIG. 1. In embodiments, datastore 275 can be the same as, or substantially similar to, remote database 130, persistent storage 113, and/or storage 124 of FIG. 1.

The MPMS 205 can be configured to manage prompts provided to ML models 290 to improve ML model output 297 performance. MPMS 205 can access prompts from prompt inputs 260 and 270 of respective ML interfaces 257 and 267 of clients 255 and 265. Similarly, MPMS 205 can access prompts from prompt input 295 of ML interface 292 of ML model 290. However, MPMS 205 can access and manage prompts from any other suitable source. While FIG. 2 only depicts a single ML model 290, any suitable number of ML models 290 can be accessed to perform the functionalities disclosed herein. For explanation purposes, ML model 290 may be referred to as a plurality of ML models 290 through discussion of potential embodiments and examples of the present disclosure.

The MPMS 205 can be configured to embed an accessed prompt (e.g., input into an ML model 290 during run-time) into a prompt vector. The MPMS 205 can be configured to perform a similarity search using the prompt vector against a datastore 275 including prompt vectors 285. The similarity search may return a plurality of matching prompt vectors corresponding to respective prompts. The MPMS 205 can be configured to select a matching prompt vector (e.g., based on relevance and/or performance metrics). The MPMS 205 can further be configured to update the originally accessed prompt based on the matching prompt identified during the similarity search. The updated prompt can then be provided to ML model 290 to receive an ML model output 297.

The MPMS 205 includes a historical data collector 210, a historical data analyzer 215, a prompt vectorization module 220, a prompt search module 225, a prompt manager 230, a monitoring module 235, and an ML model training component 240. The functionalities of the historical data collector 210, historical data analyzer 215, prompt vectorization module 220, prompt search module 225, prompt manager 230, monitoring module 235, and ML model training component 240 can be processor-executable instructions that can be executed by a dedicated or shared processor using received inputs.

In embodiments, components/functionalities of the MPMS 205 can be distributed across different computing components and/or resources over network 250. For example, each individual component and/or combinations of components depicted in FIG. 2 can be implemented as microservices. As another example, components and/or combinations thereof depicted in FIG. 2 can be containerized to bundle related applications and dependencies together for distribution over network 250.

The historical data collector 210 can be configured to obtain and store historical prompt data 280. The prompt data 280 can include input prompts and respective ML model outputs obtained based on the input prompts (e.g., based on ML model execution on the input prompt). Further, the prompt data 280 can include various data related to ML model output performance and statistics. For example, prompt data 280 can include metadata associated with an input prompt (e.g., the specific characters of a prompt, a time stamp indicating when the prompt was entered, user details of a user who input the prompt, contextual data associated with the prompt, index usage within the prompt, specific data locations referenced within the prompt, etc.), performance metrics related to ML model execution of the input prompt (e.g., execution time, resource usage, input/output (I/O) operations, success rate, etc.), and data distribution statistics (e.g., specific tables or data locations accessed during ML model execution, the size of accessed tables, index usage associated with data locations, etc.) associated with the ML model execution of the input prompt. Thus, prompt data 280 can indicate metadata associated with each accessed prompt, performance metrics associated with ML model execution on each accessed prompt, and data distribution statistics indicating data accesses used to provide ML model outputs associated with each accessed prompt.

As an example, assume a first prompt “P1” is: “SELECT * FROM orders WHERE order date >=‘2023-01-01’.” Upon execution of the first prompt P1 by ML model 290, historical data collector 210 can be configured to obtain a query log indicating the text of the first prompt (e.g., or a natural language query (e.g., “Get all orders placed this year”) that was used to generate the first prompt), metadata of the first prompt (e.g., a date the first prompt was generated, a user that generated the first prompt, query statements used in the first prompt), performance metrics associated with ML execution of the first prompt (e.g., 1.2 second execution time, 25% processor utilization, 25% memory utilization, 500 I/O operations), and data distribution statistics (e.g., the table “orders” has 1 million records) associated with ML execution of the first prompt to produce an ML output. The above data associated with the first prompt P1 can be stored in prompt data 280, to be used for ML model prompt management by MPMS 205.

Prompt data 280 can be embedded and used to perform similarity searches based on newly received prompts for the purpose of modifying newly received prompts to improve ML model 290 performance and/or ML model 290 output quality, to be discussed further herein.

The historical data analyzer 215 can be configured to analyze the prompt data 280 to ascertain insights from the prompt data 280. For example, the historical data analyzer 215 can be configured to identify patterns, trends, and performance bottle necks related to input prompts and ML model outputs. For example, the historical data analyzer 215 can be configured to ascertain one or more bottlenecks causing poor performance of an ML model with respect to an input prompt. Further, the historical data analyzer 215 can be configured to identify a reason for the one or more identified bottle necks (e.g., a bottleneck cause). As another example, historical data analyzer 215 can be configured to identify patterns in input prompt usage. For example, if input prompts are in a query language (e.g., structured query language (SQL)), historical data analyzer 215 can be configured to determine query patterns associated with input prompts, such as join frequency, filtering condition frequency, and other patterns associated with query language statements. The historical data analyzer 215 can be configured to associate query patterns with performance metrics of an ML model that generated outputs on the prompts. For example, specific query statements used within input prompts can be statistically classified with respect to performance metrics (e.g., a first query statement has a first average execution time, a second query statement has a first average resource utilization, a third query statement has a first average number of I/O operations, etc.). Relationships (e.g., statistical classifications) between prompt pattern usage and performance metrics can be used for prompt modification purposes by the MPMS 205.

Historical data analyzer 215 can further be configured to analyze changes in data structures (e.g., table sizes and locations) accessed by an ML model and can ascertain how such changes affect ML model execution performance. As such, historical data analyzer 215 can monitor and store data distribution statistics as they relate to ML model execution performance. Data distribution statistics can be used for prompt modification purposes, enabling the MPMS 205 to modify prompts such that ML model execution is able to more efficiently traverse (e.g., search) data. As an example, referring back to the first prompt, P1: “SELECT * FROM orders WHERE order_date >=‘2023-01-01’;” if the size of the table “orders” is reduced from 1 million records to 500,000 records, and ML model execution of the first prompt P1 on the reduced size table “orders” yields a 0.3 second reduction in execution time, the historical data analyzer 215 can be configured to record the performance change resulting from the data distribution change.

Historical data analyzer 215 can further be configured to analyze user data associated with specific users to determine patterns associated with specific users, such as language preferences, formatting preferences, frequent prompt topics, and other information. User data can be considered for the purpose of modifying future prompts input by the user or similar users to better match user preferences, prompt relevance, and ML output quality. The analysis by historical data analyzer 215 can be used to manage prompts provided to ML model 290. For example, insights gleaned from historical data analyzer 215 can be used to modify prompts and generate new prompts.

The prompt vectorization module 220 can be configured to access prompt data 280 and generate prompt vectors 285. Prompt vectors 285 can be vector embeddings that transform data associated with a prompt (e.g., words, sentences, numerical data) into an array of numbers (e.g., an n-dimensional array, a feature vector, embeddings, etc.) representing the input data's features. For example, historical prompt data 280 such as metadata associated with an input prompt, performance metrics, and/or data distribution statistics can be embedded by prompt vectorization module 220 to generate one or more prompt vectors 285. In embodiments, a single prompt can have multiple corresponding prompt vectors 285. For example, a first prompt vector can correspond to metadata of a first prompt, a second prompt vector can correspond to performance metrics of ML model 290 executing the first prompt, and a third prompt vector can correspond to data distribution statistics of ML model 290 executing the first prompt.

Alternatively, a single prompt can have a single prompt vector that incorporates all data features of the prompt and its execution characteristics by the ML model 290.

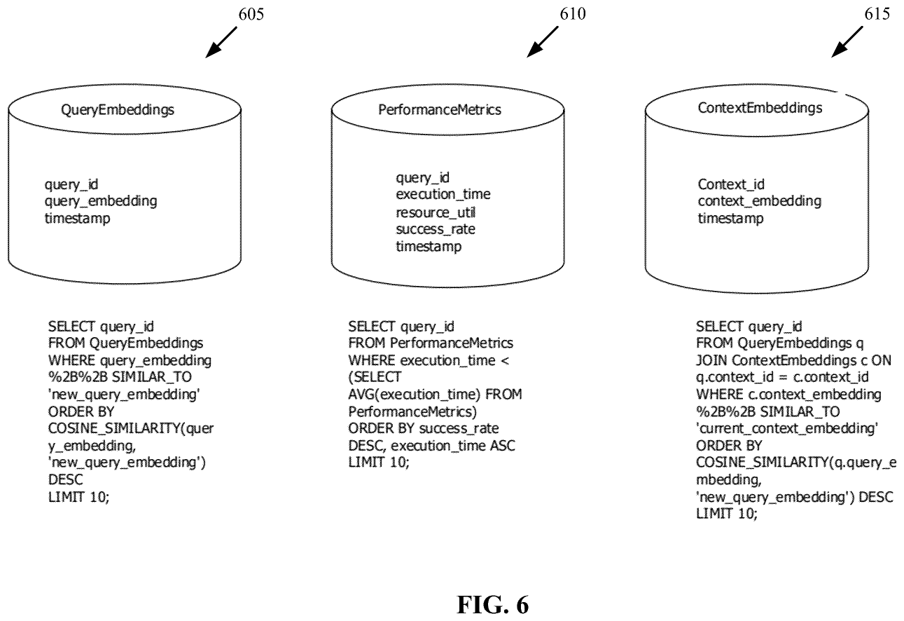

Any suitable embedding/vectorization technique can be used to embed data associated with a prompt. Embedding can be completed by a trained machine learning model (e.g., a neural network) configured to transform data into a dense representation in a multi-dimensional space. Example embedding models include, but are not limited to word2vec, FastText, bag-of-words, and term frequency-inverse document frequency (tfidf), among others. Prompt vectors 285 can be stored in datastore 275 and in any suitable format. Further, prompt vectors 285 can be organized in any suitable manner (e.g., in a tabular format) such that similarity searches can be performed against the prompt vectors 285 within datastore 275. Each prompt vector 285 can be mapped to (e.g., relationally associated with) a corresponding prompt. FIG. 6 depicts exemplary prompt vectors 285 that may be searched within datastore 275, to be discussed further herein.

Prompt vectorization module 220 can be configured to embed historical prompt data 280 as well as newly received prompts (e.g., accessed over network 250). For example, upon user input of a new prompt within prompt input 295 of ML interface 267, the new prompt can be accessed by MPMS 205 to facilitate prompt management capabilities. For example, the prompt vectorization module 220 and/or prompt manager 230 can be configured to pre-process, format, refine, and embed the new prompt into a format suitable/desirable for performing a similarity search. For example, if a natural language prompt received at prompt input 295 is “Get all orders placed this year,” the prompt vectorization module 220 and/or prompt manager 230 can be configured to pre-process and format the prompt into an SQL format. In this example, the input prompt can be used to generate a plurality of options within an SQL format:
1. P1: “SELECT * FROM orders WHERE order_date >=‘2023-01-01’;”
2. P2: “SELECT order_id, order_date FROM orders WHERE order_date BETWEEN ‘2023-01-01’ AND CURDATE( );”
3. P3: “SELECT * FROM orders WHERE YEAR(order_date)=YEAR(CURDATE( ));”

As shown above, three SQL prompts are generated based on the natural language input. As such, the prompt vectorization module 220 and/or prompt manager 230 can be configured to pre-process, format, and/or refine newly received prompts such that they can be utilized by MPMS 205 for downstream processing. In embodiments, the pre-processing and formatting performed by MPMS 205 can be based on the ML models 290 that the MPMS 205 is interfacing. For example, when ML models 290 are configured to receive data in an SQL format, then MPMS 205 can be configured to pre-process, format, and/or refine newly received prompts into the SQL format (e.g., shown in the example above). In embodiments, the pre-processing, formatting, and/or refining performed by MPMS 205 can be based on the intent and context of the natural language of the newly received prompt. For example, components of the MPMS 205 can utilize various natural language processing (NLP) techniques to parse and analyze natural language queries. Such NLP techniques include, but are not limited to, word segmentation, lemmatization, morphological segmentation, part-of-speech (POS) tagging, stemming, sentence breaking, parsing, named entity recognition, sentiment analysis, terminology extraction, entity linking, relationship extraction, and others. Based on the NLP analysis, query statements and syntactical structure of the input prompt can be determined and generated.

In embodiments, the generated prompt options (e.g., shown as P1, P2, and P3, above) can be based on historical data analyzer 215. For example, prompt options P1, P2, and P3 can be generated based on historical query statement patterns (e.g., statistical classifications) as they relate to performance metrics. As such, insights gleaned from historical data analyzer 215 can be used to refine new prompts based on desired goals (e.g., desired execution time, desired resource utilization, desired I/O operation counts, desired data distributions used to retrieve ML responses, etc.). For example, if a first query statement (e.g., a join) is associated with a given performance metric (e.g. a fast execution time), an initial refined input query can be generated to include the first query statement based on the performance metric.

Upon pre-processing, formatting, and/or initially refining (e.g., based on historical data analyzer 215) the newly received prompt, the prompt vectorization module 220 can be configured to embed the newly received prompt into one or more prompt vectors 285. The prompt vector(s) 285 of the newly received prompt can be utilized by the prompt search module 225 to perform a similarity search against the datastore 275.

The prompt search module 225 can be configured to perform a similarity search using the embedded newly received prompt (e.g., one or more feature vectors capturing dimensional characteristics of the newly received prompt) against the datastore 275 to identify matching prompt vectors 285. The similarity search can compare the prompt vector(s) associated with the newly received prompts to the historical prompt vectors 285 using a distance metric/threshold.

This enables the prompt search module 225 to identify historical prompt vectors 285 that match the newly received prompt based on similarity to one or more criteria. For example, the similarity search can be executed to return historical prompt results that are relevant to the newly received prompt, such as based on textual similarity and/or shared metadata characteristics (e.g., contextual data such as a same user identifier, a same/similar date, etc.). In embodiments where the newly received prompt is executed on by ML model 290, then additional criteria that relate to performance metrics and data distribution statistics can be used to perform the similarity search. For example, the similarity search can be completed based on execution time, resource utilization, I/O operations, and/or data location access statistics such as table size and index usage. Thus, similarity searching can be performed to identify textually similar prompts, prompts with similar performance metrics, prompts that cause access to similar data locations, prompts with similar metadata characteristics, and the like.

Similarity searching can be performed between prompt vectors (e.g., one or more prompt vectors of the newly received prompt and one or more prompt vectors of one or more corresponding historical prompts) using any suitable distance metric. For example, the similarity search can be based on a Euclidean distance (e.g., a straight-line distance between two vectors that considers magnitude), cosine distance (e.g., a cosine angle between two vectors, focusing more on direction than magnitude), or any other manners for quantifying distance between vectors. In embodiments, the prompt search module 225 returns prompt vectors that are within a distance threshold (e.g., a cosine distance threshold). Prompts that are mapped to the matching prompt vectors can then be identified as matching prompts, to be used to modify the input prompt.

As discussed above, the prompt manager 230 can be used to initially pre-process, format, and/or refine a new input prompt received from a user. This can enable the prompt vectorization module 220 to embed the updated newly received prompt for similarity search purposes. In addition to modifying the input prompt for the purpose of performing a similarity search, the prompt manager 230 can be configured to modify the input prompt based on the results of the similarity search. As such, the prompt manager 230 is configured to manage prompts in a manner to facilitate similarity searching and to update prompts based on similarity search results. Thus, a new prompt submitted by a user may undergo an initial refinement to facilitate similarity searching and a subsequent refinement to update the prompt based on similarity search results. Modification of prompts based on similarity search results can be completed to improve ML model 290 performance and/or ML output quality. Further, modification of the newly received prompt can be completed to better match user intent/preference.

In embodiments, the prompt manager 230 modifies an input prompt based on a matching prompt identified by prompt search module 225. As an example, an input prompt can be updated to be similar to (e.g., via character replacement/text editing) a matching prompt. The matching prompt that the newly received prompt can be updated on can be selected based on one or more criteria. For example, matching prompts can be ranked with respect to each other based on performance metrics and data distribution statistics. In embodiments, a top ranked matching prompt with respect to a given criterion (e.g., a top ranked execution time (e.g., a fastest execution time), a top ranked resource utilization (e.g., a lowest resource utilization), a top ranked data distribution statistic (e.g., a smallest table size), a top ranked success rate, etc.) or multiple criteria can be selected and used to modify the newly received prompt. Modifying the newly received prompt can include editing alphanumeric characters within the newly received prompt in a particular manner based on a determined modification.

In embodiments, features associated with multiple matching prompts can be collectively used to modify the newly received prompt. For example, a first query statement associated with a first matching prompt and a second query statement associated with a second matching prompt can be used to update the newly received prompt (e.g., by integrating the first and second query statements into the newly received prompts). Any suitable number of features associated with any suitable number of matching prompts can be used to modify the newly received prompt without departing from the spirit and scope of the present disclosure.

In embodiments, multiple factors can be considered simultaneously when determining a top ranked matching prompt. For example, a top ranked matching prompt can be selected based on a combination of success rate (e.g., a proportion of valid/satisfactory ML outputs generated using the prompt compared to invalid (e.g., hallucinations)/unsatisfactory ML outputs generated using the prompt) and execution time. In embodiments, query statements from matching prompts can be integrated into an input prompt used to execute the similarity search based on performance metrics and/or data distribution statistics. For example, if a top ranked matching prompt includes a particular query statement (e.g., a union statement), the particular query statement can be integrated into the new input prompt.

In embodiments, prompt manager 230 can be configured to modify new prompts based on the analysis completed by historical data analyzer 215. For example, in embodiments, prompt manager 230 can be configured to make predictions regarding expected performance metrics and data distribution statistics based on characteristics of the input prompt (e.g., filtering conditions used, index usage, table sizes referenced). In these embodiments, the prompt manager 230 can be configured to update the input prompt and/or generate new prompts using characteristics of the input prompt as they relate to performance metrics and data distribution statistics. This can be completed prior to, or after, modification of the prompt based on the similarity search.

In embodiments, prompt manager 230 can be configured to generate multiple prompt candidates based on similarity search results and/or based on historical data insights. One or more generated prompt candidates can be executed by ML model 290 to produce respective outputs. As discussed herein, “generating” a new prompt can include editing an input prompt (or a refined version thereof) to generate a new version of the prompt. As such, generating a new prompt can refer to modifying an existing prompt (e.g., a modified version of an existing prompt can be referred to as a newly generated prompt). ML output results generated from prompt candidates can be provided to the user via ML interface 267. In embodiments, a prompt candidate can be selected as a finalized prompt based on a desired goal. For example, a finalized prompt can be selected from a plurality of prompt candidates based on a performance metric (e.g., a fastest execution time), user data (e.g., the candidate matches user preferences), and data distribution statistics (e.g., the prompt requires access to fewer data locations and/or data locations of smaller sizes).

The monitoring module 235 can be configured to monitor ML model 290 performance on execution of prompts modified by and/or generated by prompt manager 230. For example, if three prompt candidates are generated based on similarity search results, the monitoring module 235 can be configured to analyze ML model execution on the three prompts. This can include collecting real-time data on performance metrics such as query execution time, resource utilization, and I/O operation count. The monitoring module 235 can further be configured to identify unusual patterns and deviations in performance metrics associated with specific prompts. The monitoring module 235 can be configured to identify bottlenecks and causes of the identified bottlenecks with respect to performance metrics of prompt candidates. The results obtained by monitoring module 235 can be ingested by historical data collector 210 and historical data analyzer 215. For example, each prompt generated by prompt manager 230 based on similarity search results can have their prompt data 280 vectorized into prompt vectors 285 to be used for future prompt modifications.

Referring now to a detailed example implementing embodiments of the present disclosure, assume an input prompt is received that includes a natural language query “Get all orders placed this year.” The prompt vectorization module 220 and prompt manager 230 can be configured to perform an NLP analysis of the natural language query to obtain NLP data such as parts of speech, semantics, and entities within the input prompt (e.g., the prompt is pre-processed). Based on the NLP analysis of the input prompt the prompt can be reformatted into a particular format (e.g., SQL). For example, the prompt can be reformatted into an SQL format “SELECT order_id, order_date FROM orders WHERE order_date BETWEEN ‘2023-01-01’ AND CURDATE( );” based on the context and intent of the natural language request. In embodiments, the SQL format can be refined based on historical data analyzer 215. For example, if historical prompts have better performance when specifying a simple filter (e.g., greater than or equal to) rather than a range filter (e.g., dates between X and Y), then the prompt can be refined to recite “SELECT * FROM orders WHERE order_date >=‘2023-01-01’ ;. ” The refined prompt “SELECT * FROM orders WHERE order_date >=‘2023-01-01’;” is then embedded by prompt vectorization module 220 to generate one or more prompt vectors.

The prompt search module 225 can then perform a similarity search using the new embedded prompt against prompt vectors 285 within datastore 275. The similarity search can return similarity search results indicating a plurality of matching prompt vectors corresponding to respective prompts. Further, the similarity search can be based on one or more features of the new embedded prompt (e.g., text similarity, metadata similarities, query statement similarity, data location similarity, performance similarity, etc.). In this example, the MPMS 205 can be configured to select a top ranked matching prompt vector based on a particular criterion or multiple criteria. For example, a prompt vector with a highest-ranking performance metric (e.g., execution time) can be selected. The refined new prompt “SELECT * FROM orders WHERE order_date >=‘2023-01-01’;” can then be updated based on a second prompt corresponding to the matching prompt vector. For example, if the top ranked matching prompt vector is “SELECT * FROM orders WHERE YEAR(order_date)=YEAR(CURDATE( )); ,” then aspects of the top ranked matching prompt vector can be used to modify the refined new prompt. In embodiments, a plurality of candidate prompts can be generated based on the similarity search results.

Thereafter a finalized prompt can be selected from the plurality of candidate prompts (e.g., based on performance metrics, user preferences, data locations, index usage, etc.).

In embodiments, the prompt monitoring module 235 can be configured to define input prompt generation rules based on performance metrics and/or data distribution statistics associated with ML model execution of prompts. For example, if a given query statement results in degraded ML model execution performance (e.g., slow execution time, high resource utilization, high I/O count) on average over a plurality of prompts containing the given query statement, the monitoring module can be configured to set a prompt generation rule to prevent use of the given query statement. Prompt generation rules can be set based on specific characters permitted to be used in prompts, specific query statements allowed to be used in prompts, prompt length, and prompt structure organization, among other rules. When one or more prompt generation rules are set, prompt manager 230 can be configured to ensure that prompts are not refined/generated in a manner to violate a rule set within the prompt generation rules.

The ML model training component 240 can be configured to train (e.g., update parameters of) ML model 290 (e.g., or other ML models not shown in FIG. 2). The ML model training component 240 can be configured to update ML model 290 in a supervised or unsupervised manner to improve ML execution on prompts and to improve ML output quality.

For example, the ML model 290 can be trained in a supervised or unsupervised manner based on refined prompts generated by prompt manager 230. As such, trained ML models 290 may be configured to produce improved ML outputs (e.g., improved success rate) on refined prompts with improved performance metrics (e.g., faster execution times, lower resource utilization, lower I/O count). For example, refined prompts generated by MPMS 205 can be input into ML model 290 and corresponding ML outputs can be received. Labeling of ML outputs (e.g., as valid/accurate responses or invalid/inaccurate responses) can be completed. The ML model can then be trained with positive feedback for refined prompts that valid/accurate ML outputs were generated for (e.g., ML model parameters can be adjusted to increase the frequency in which valid/accurate ML outputs are obtained) and negative feedback for refined prompts that invalid/inaccurate ML outputs were generated for (e.g., ML model parameters can be adjusted to decrease the frequency in which invalid/inaccurate ML outputs are obtained). Accordingly, the ML model can be trained to improve performance with refined prompts produced by MPMS 205.

It is noted that FIG. 2 is intended to depict the representative major components of an example computing environment 200. In some embodiments, however, individual components can have greater or lesser complexity than as represented in FIG. 2, components other than or in addition to those shown in FIG. 2 can be present, and the number, type, and configuration of such components can vary.

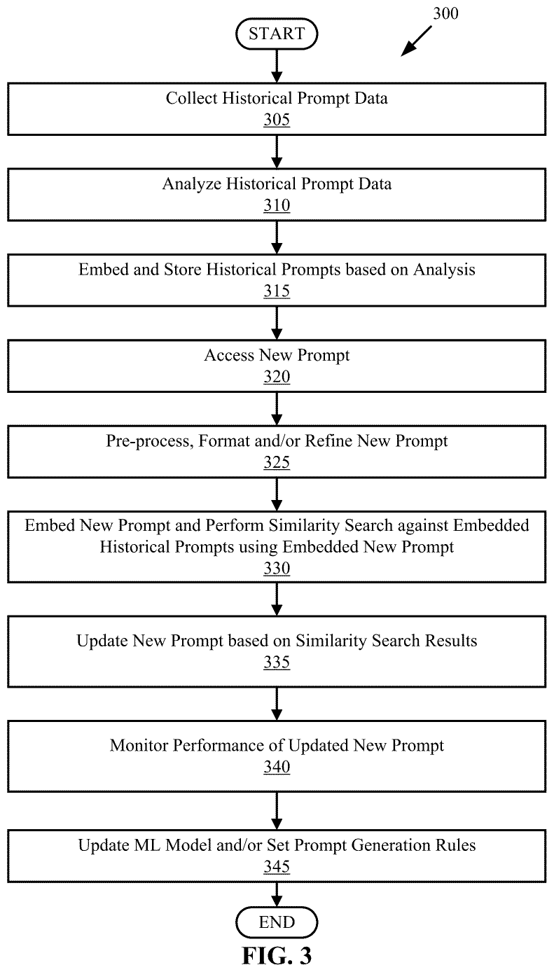

Referring now to FIG. 3, shown is a flowchart of an example method 300 for ML model prompt management, in accordance with embodiments of the present disclosure. One or more operations of method 300 can be completed by one or more processing circuits (e.g., computer 101, end user device 103, remote server 104, clients 255/265, MPMS 205, datastore 275, ML model 290, etc.).

Method 300 initiates at operation 305, where historical prompt data is collected. Historical prompt data can be the same, or a substantially similar to, prompt data 280 discussed with respect to FIG. 2. Further, historical prompt data can be collected in the same, or a substantially similar manner, as discussed with respect to the historical data collector 210 of FIG. 2. For example, historical prompt data that can be collected include prompts, prompt metadata, ML model prompt execution performance metrics, and data distribution statistics as they relate to ML model prompt execution.

The historical prompt data is then analyzed. This is illustrated at operation 310. Analyzing historical prompt data can be completed in the same, or a substantially similar manner, as described with respect to the historical data analyzer 215 of FIG. 2. For example, analyzing the historical prompt data can include identifying trends, patterns, and/or bottlenecks associated with historically input prompts and ML model execution results. For example, relationships between prompt characters/query statements and performance metrics can be determined. Further, historical prompt data analysis can include determining user preferences based on prompts that were historically input by respective users. Analysis completed at operation 310 can be used to refine prompts to facilitate similarity searching (e.g., at operation 325) and/or to refine prompts based on similarity search results (e.g., at operation 335). In embodiments, historical prompt analysis can be completed by one or more machine learning models configured to ascertain patterns (e.g., user preference patterns, performance metric patterns, data distribution patterns, metadata patterns, etc.) associated with specific input prompts and corresponding ML output execution results.

Historical prompt data is then embedded into prompt vectors and stored. This is illustrated at operation 315. Embedding prompt data can be completed in the same, or in a substantially similar manner, as discussed with respect to the prompt vectorization module 220 of FIG. 2. For example, data associated with ML model execution of a given prompt, such as prompt metadata, performance metrics, and/or data distribution statistics, can be embedded and converted into one or more prompt vectors. The prompt vectors serve as a dense representation of the data in a multi-dimensional space that can be used for similarity searches for the purpose of prompt searching, prompt modification, and prompt generation.

A new prompt is accessed. This is illustrated at operation 320. Accessing a new prompt can include collecting, requesting, or otherwise obtaining a new prompt that is input to attempt to obtain an ML model (e.g., an LLM) output. For example, new prompts can be accessed from prompt inputs 260, 270 of clients 255, 265 and/or from prompt input 295 of ML model 290. In embodiments, the new prompt is in a natural language format.

The new prompt is then pre-processed, formatted, and/or refined. This is illustrated at operation 325. Pre-processing, formatting, and/or refining the new prompt can be completed in the same, or a substantially similar manner, as discussed with respect to the prompt vectorization module 220 and prompt manager 230 of FIG. 2. For example, pre-processing can include performing various NLP operations that enable constituent portions of natural language within the new prompt to be parsed and analyzed. Formatting can include converting the natural language of the prompt into a particular structured format (e.g., SQL). Refining can include updating the accessed input prompt based on historical analyses performed at operation 310 (e.g., based on user preferences, based on performance metrics of particular query statements, based on data distribution statistics indicating data access locations). In embodiments, operation 325 is completed to facilitate embedding and similarity searching at subsequent operations. For example, pre-processing, formatting, and refining a prompt can be completed to enhance embedding of the prompt (e.g., produce improved embedding results by an embedding model). As another example, pre-processing, formatting, and refining a prompt can be completed to enhance similarity searching using the prompt (e.g., produce better similarity search results by a decision function that utilizes a distance metric/threshold).

The new prompt is then embedded and a similarity search is performed against embedded historical prompts using the embedded new prompt. This is illustrated at operation 330. Embedding the new prompt can be completed in the same, or a substantially similar manner, as described with respect to the prompt vectorization module 220 of FIG. 2. Performing the similarity searching against embedded historical prompts using the embedded new prompt can be completed in the same, or a substantially similar manner, as described with respect to the prompt search module 225 of FIG. 2. The similarity search can be performed using one or more features (e.g., criteria or characteristics) of the embedded new prompt, such as alphanumeric characters of the new prompt, query statements recited in the new prompt, data locations recited in the new prompt, performance metrics (e.g., in instances where an ML output is obtained using the new prompt) of ML model execution of the new prompt, contextual data associated with the new prompt (e.g., metadata characteristics) and the like. The similarity search can return similarity search results including one or more matching prompt vectors (e.g., corresponding to respective prompts).

The new prompt (e.g., or updated version of the new prompt produced at operation 325) is then updated based on the similarity search results. This is illustrated at operation 335. Updating the new prompt can be completed in the same, or a substantially similar manner, as discussed with respect to the prompt manager 230 of FIG. 2. For example, updating the new prompt can include modifying alphanumerical characters, query statements, syntactic structure, etc. of the new prompt based on the similarity search results. In embodiments, the new prompt is updated based on a matching prompt. For example, the matching prompt may be a prompt returned from the similarity search results with a highest relevance and/or highest performance. Features of the matching prompt can then be used to modify the new prompt. For example, the new prompt can be modified to include one or more characters, query statements, data location recitations, etc. that are present in the matching prompt. In embodiments, multiple prompt candidates can be generated at operation 335 based on similarity search results.

Performance of the updated new prompt (e.g., or multiple prompt candidates) is then monitored. This is illustrated at operation 340. Monitoring prompt performance can be completed in the same, or a substantially similar manner, as described with respect to the monitoring module 235 of FIG. 3. In embodiments where multiple prompt candidates are generated, results of the monitoring can be used to select a finalized prompt from a plurality of prompt candidates.

The ML model is then trained using the new prompt and/or prompt generation rules are set based on the monitoring. This is illustrated at operation 345. ML model training can be completed in the same, or a substantially similar manner, as described with respect to the ML model training component 240 of FIG. 2. Prompt generation rules can be set in the same, or a substantially similar manner, as described with respect to the prompt monitoring module 235 of FIG. 2.

The aforementioned operations can be completed in any order and are not limited to those described. Additionally, some, all, or none of the aforementioned operations can be completed, while still remaining within the spirit and scope of the present disclosure. For example, in embodiments, operation 325 may not be completed in instances where pre-processing, formatting, and/or refining the new prompt is not required.

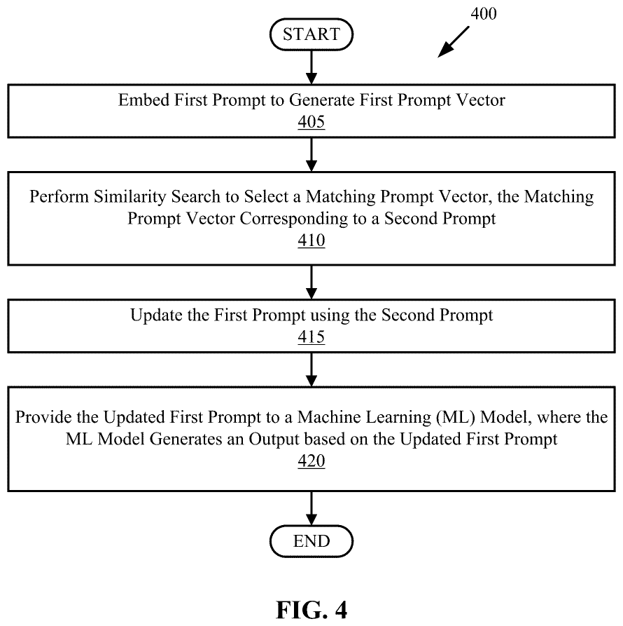

Referring now to FIG. 4, shown is a flowchart of an example method 400 for ML model prompt management, in accordance with embodiments of the present disclosure. One or more operations of method 400 can be completed by one or more processing circuits (e.g., computer 101, end user device 103, remote server 104, clients 255/265, MPMS 205, datastore 275, ML model 290, etc.).

Method 400 initiates at operation 405, where a first prompt is embedded to generate a first prompt vector. This is illustrated at operation 405. Embedding the first prompt to generate the first prompt vector can be completed in the same, or a substantially similar manner, as described with respect to the prompt vectorization module 220 of FIG. 2

A similarity search is performed to select a matching prompt vector, the matching prompt vector corresponding to a second prompt. This is illustrated at operation 410. Performing the similarity search can be completed in the same, or a substantially similar manner, as described with respect to the prompt search module 225 of FIG. 2. The matching prompt vector can be selected from a plurality of matching prompt vectors based on a top-ranked criterion or multiple criteria, such as one or more performance metrics.

The first prompt is then updated using the second prompt. This is illustrated at operation 415. In some embodiments, the first prompt can be edited to include features of the second prompt (e.g., similar alphanumeric characters, query statements, data location recitations, etc.). In some embodiments, the second prompt can be selected to replace the first prompt (e.g., the second prompt is used instead of the first prompt). In some embodiments, one or more candidate prompts can be generated at operation 415. For example, a plurality of candidate prompts can be generated at operation 415 and a finalized prompt can be selected from the plurality of candidate prompts.

The updated first prompt (e.g., finalized prompt selected from a plurality of candidate prompts, edited version of the first prompt, or the second prompt if it is selected to replace the first prompt) is then provided to an ML model, where the ML model generates an output based on the updated first prompt. This is illustrated at operation 420.

While not shown, additional operations can be performed prior to, during, or subsequent to operation 420. For example, ML model training can then occur based on ML model execution of the updated first prompt (e.g., based on a labeled result of the ML output). Further, prompt generation rules can be updated based on ML model execution of the updated first prompt. Further still, the updated first prompt can be embedded and stored within a prompt vector database for use in future similarity searches.

The aforementioned operations can be completed in any order and are not limited to those described. Additionally, some, all, or none of the aforementioned operations can be completed, while still remaining within the spirit and scope of the present disclosure.

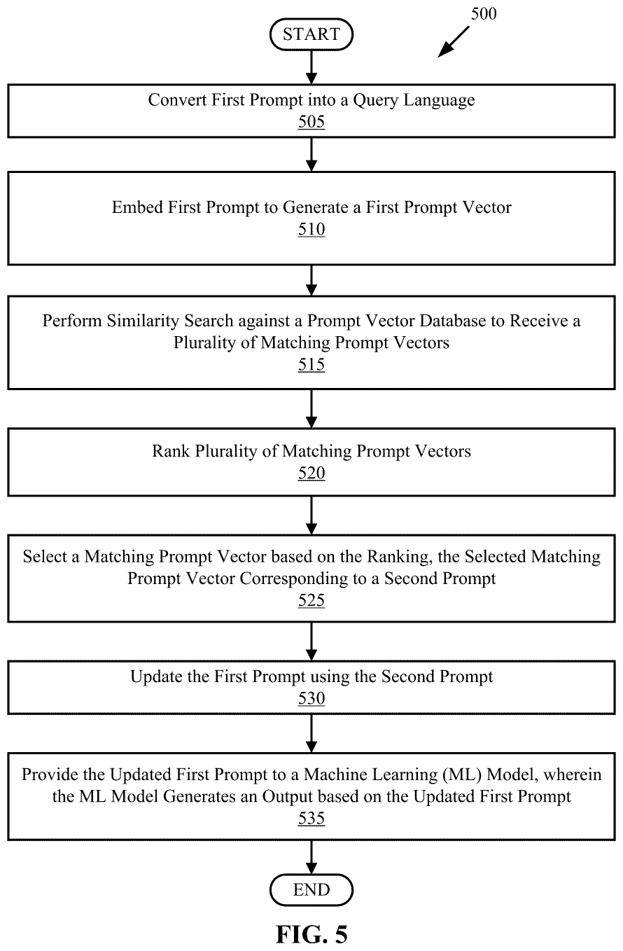

Referring now to FIG. 5, shown is a flowchart of an example method 500 for ML model prompt management, in accordance with embodiments of the present disclosure. One or more operations of method 500 can be completed by one or more processing circuits (e.g., computer 101, end user device 103, remote server 104, clients 255/265, MPMS 205, datastore 275, ML model 290, etc.).

Method 500 initiates at operation 505, where a first prompt is converted into a query language. For example, a new prompt input by a user and accessed by MPMS 205 can be converted into an SQL format.

The first prompt is then embedded to generate a first prompt vector. This is illustrated at operation 510. Embedding the first prompt to generate the first prompt vector can be completed in the same, or a substantially similar manner, as discussed with respect to the prompt vectorization module 220 of FIG. 2.

A similarity search is performed to obtain a plurality of matching prompt vectors corresponding to respective prompts. This is illustrated at operation 515. Performing the similarity search can be completed in the same, or a substantially similar manner, as described with respect to the prompt search module 225 of FIG. 2. For example, the matching prompt vectors may be within a threshold distance metric with respect to a given feature of the embedded first prompt (e.g., textual relevance).

The plurality of matching prompt vectors are then ranked. This is illustrated at operation 520. In embodiments, the plurality of matching prompt vectors can be ranked based on performance metrics, relevance, data distribution statistics (e.g., tables accessed, table size, etc.), or any combination thereof. For example, all matching prompt vectors can be ranked based on execution time, success rate, resource utilization, I/O count, relevance, number of tables accessed, a number of records accessed, etc.

A matching prompt vector is selected based on the ranking, where the selected matching prompt vector corresponds to a second prompt. This is illustrated at operation 525. For example, the selected matching prompt vector may have a fastest execution time, a lowest resource utilization (e.g., lowest processor and/or memory utilization), a highest success rate, a lowest I/O counter, a lowest number of tables accessed, a lowest number of records accessed, etc.

The first prompt is then updated using the second prompt. This is illustrated at operation 530. In embodiments, operation 530 can be completed in the same, or a substantially similar manner, as operation 415 of FIG. 4.

The updated first prompt (e.g., finalized prompt selected from a plurality of candidate prompts, edited version of the first prompt, or the second prompt if it is selected to replace the first prompt) is then provided to an ML model, where the ML model generates an output based on the updated first prompt. This is illustrated at operation 535.

While not shown, additional operations can be performed prior to, during, or subsequent to operation 535. For example, ML model training can then occur based on ML model execution of the updated first prompt (e.g., based on a labeled result of the ML output). Further, prompt generation rules can be updated based on ML model execution of the updated first prompt. Further still, the updated first prompt can be embedded and stored within a prompt vector database for use in future similarity searches.

The aforementioned operations can be completed in any order and are not limited to those described. Additionally, some, all, or none of the aforementioned operations can be completed, while still remaining within the spirit and scope of the present disclosure.

Referring now to FIG. 6, shown are examples of prompt vectors 285 that can be used to perform aspects of ML model prompt management, in accordance with embodiments of the present disclosure. Query embedding datastore 605 may be the same as or similar to prompt vectors 285. Each prompt within query embedding datastore 605 can include a prompt identification (e.g., “query_id”) and respective prompt vector(s) (e.g., query_embedding”). Further, each prompt can include metadata such as a timestamp, user identification, etc. As shown in FIG. 6, the query embedding datastore 605 can be queried to find prompt vectors that match a new prompt vector via cosine similarity searching. Example SQL pseudocode for executing the similarity search to return prompt vectors (e.g., with a limit of 10) matching the new prompt vector is shown below query embedding datastore 605.

As further shown in FIG. 6, a performance metrics database 610 includes performance metrics of respective prompt identifications. The performance metrics database 610 includes performance metrics such as execution time (“execution_time”), resource utilization (e.g., resource_util”), success rate (“success_rate”) and performance related metadata (e.g., timestamp). Example SQL pseudocode for searching and ranking matching prompt vectors based on performance metrics is shown. In the example shown in FIG. 6, the matching prompt vectors are selected to have a maximum average execution time and are ordered by success rate and execution time.

A context embeddings datastore 615 may also be the same as or similar to prompt vectors 285. However, the context embeddings datastore 615 may enable query specific contexts associated with input prompts. For example, context embeddings can relate to metadata associated with a given query such as user identification, time, date, location, user behavior, and the like. Thus, context embeddings datastore 615 can be queried to identify historical prompts that include similar contextual elements as a new prompt. Example SQL pseudocode for executing the similarity search to return prompt vectors (e.g., with a limit of 10) with similar contexts to a new prompt vector is shown below context embeddings datastore 615.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Advantages discussed in the present disclosure are example advantages, and embodiments of the present disclosure can exist that realize all, some, or none of any of the discussed advantages while remaining within the spirit and scope of the present disclosure.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

1. A computer-implemented method comprising:
embedding a first prompt to generate a first prompt vector;
performing a similarity search against a plurality of stored prompt vectors using the first prompt vector;
selecting a matching prompt vector from the plurality of stored prompt vectors, the matching prompt vector corresponding to a second prompt;
updating the first prompt using the second prompt; and
providing the updated first prompt to a machine learning (ML) model, wherein the ML model generates an output based on the updated first prompt.

2. The method of claim 1, wherein the similarity search returns a plurality of matching prompt vectors, wherein the selected matching prompt vector is selected from the plurality of matching prompt vectors.

3. The method of claim 2, wherein the selected matching prompt vector is selected from the plurality of matching prompt vectors based on a performance metric.

4. The method of claim 2, wherein the selected matching prompt vector is selected from the plurality of matching prompt vectors based on a success rate.

5. The method of claim 1, wherein the first prompt vector captures metadata of the first prompt, wherein the metadata is used within the similarity search to select the matching prompt vector.

6. The method of claim 1, wherein prior to embedding the first prompt, the first prompt is formatted into a query language, wherein the formatted first prompt is embedded to generate the first prompt vector.

7. The method of claim 1, wherein updating the first prompt using the second prompt includes generating a plurality of prompt candidates, wherein the updated first prompt is a finalized prompt selected from the plurality of prompt candidates based on a desired goal.

8. The method of claim 7, wherein the desired goal is based on a performance metric of the finalized prompt as compared to performance metrics of other prompts within the plurality of prompt candidates.

9. The method of claim 1, wherein the similarity search is performed against a prompt vector database to return a plurality of matching prompt vectors based on cosine similarity.

10. A system comprising:
a processor set;
one or more computer-readable storage media; and
program instructions stored on the one or more computer-readable storage media to cause the processor set to perform operations comprising:
embedding a first prompt to generate a first prompt vector;
performing a similarity search against a plurality of stored prompt vectors using the first prompt vector;
selecting a matching prompt vector from the plurality of stored prompt vectors, the matching prompt vector corresponding to a second prompt;
updating the first prompt using the second prompt; and
providing the updated first prompt to a machine learning (ML) model, wherein the ML model generates an output based on the updated first prompt.

11. The system of claim 10, wherein the similarity search returns a plurality of matching prompt vectors, wherein the selected matching prompt vector is selected from the plurality of matching prompt vectors based on a performance metric.

12. The system of claim 11, wherein the performance metric used to select the matching prompt vector from the plurality of matching prompt vectors is an execution time, wherein the selected matching prompt vector has a top-ranked execution time.

13. The system of claim 11, wherein the performance metric used to select the matching prompt vector from the plurality of matching prompt vectors is a resource utilization, wherein the selected matching prompt vector has a top-ranked resource utilization.

14. The system of claim 11, wherein the selected matching prompt vector is selected from the plurality of matching prompt vectors based on the performance metric and a success rate.

15. The system of claim 10, wherein the similarity search returns a plurality of matching prompt vectors, wherein the selected matching prompt vector is selected from the plurality of matching prompt vectors based on data distribution statistics of the selected matching prompt vector as compared to other matching prompt vectors.

16. A computer program product comprising:
one or more computer readable storage media; and
program instructions collectively stored on the one or more computer readable storage media to perform operations comprising:
embedding a first prompt to generate a first prompt vector;
performing a similarity search against a plurality of stored prompt vectors using the first prompt vector;
selecting a matching prompt vector from the plurality of stored prompt vectors, the matching prompt vector corresponding to a second prompt;
updating the first prompt using the second prompt; and
providing the updated first prompt to a machine learning (ML) model, wherein the ML model generates an output based on the updated first prompt.

17. The computer program product of claim 16, wherein updating the first prompt using the second prompt includes generating a plurality of prompt candidates.

18. The computer program product of claim 17, wherein the plurality of prompt candidates are executed on by the ML model to produce respective ML outputs.

19. The computer program product of claim 18, wherein the updated first prompt is a finalized prompt selected from the plurality of prompt candidates based on a top-ranked performance metric with respect to the ML model execution.

20. The computer program product of claim 16, wherein the similarity search is performed against a prompt vector database to return a plurality of matching prompt vectors based on a distance metric, wherein the selected matching prompt vector has a closest distance metric.
